(19) United States
(12) Patent Application Publication
(10) Pub. No.: US 2018/0197287 A1
(43) Pub. Date: Jul. 12, 2018

(54) PROCESS OF USING MACHINE LEARNING FOR CANNABIS PLANT HEALTH DIAGNOSTICS

(71) Applicant: Adrian Ronaldo Macias, (US)

(72) Inventor: Adrian Ronaldo Macias, Carlsbad, CA (US)

(21) Appl. No.: 15/865,260

(22) Filed: Jan. 9, 2018

Related U.S. Application Data
(60) Provisional application No. 62/443,806, filed on Jan. 8, 2017.

(51) Int. Cl. G06T 7/00; G06N 99/00; G06N 5/04

(52) U.S. Cl. CPC G06T 7/0004; G06N 99/005; G06N 5/04; G06T 2207/10016; G06T 2207/20081; G06T 2207/10004; G06T 2207/30188

(57) ABSTRACT

The ability to make real-time and high accuracy diagnostic determinations is critical for high volume, high value crops, such as cannabis. Advances in learning-based algorithms provide an improved way to perform plant health diagnostics. A significantly large content library of plant health specific to cannabis plants may be used to train a machine learning algorithm to correlate input data with a generated output diagnosis. Maintaining and growing the underlying content library is an important consideration in a deployed solution. Diagnostic results may also include remediation recommendations to allow users to take immediate action on their plant.

### BACKGROUND

### Field of the Invention

The present invention relates generally to identification of plant health conditions, and specifically as such for a cannabis plant. In particular, the present invention relates to a process and platform used to facilitate user submitted content for diagnosis and to return a remediation recommendation specific to the diagnosis.

### Description of the Related Art

The current state of the art in plant diagnostics is using expert human interaction, where an on-site person is responsible for applying their trade skill to identifying the current conditions of the plant. Very little diagnostic decisions have been automated. No existing automation has shown the ability to fully classify the diagnostics amongst a large set of possible diagnosis that exist for plant health.

The current state of the art in algorithm based classification uses machine learning algorithms. Classification is the process of taking input data and producing a set of output scores that represent a high probability set of possible classes for the input data. Examples include using classification algorithms to identify a cat, or a dog in an input picture. Machine learning is a sub-class of artificial intelligence where machines or computers can make decisions by learning and do not need to be explicitly programmed to perform a task. The machine learning algorithm must be pre-trained using a content database. This database contains tagged content that represents the types of data that will be later classified by the machine.

While machine learning algorithms are appearing in many modern applications, thus far, they have not been used specifically for cannabis plant health diagnostics.

For the purpose of this invention, “cannabis” is defined as a genus of plant with species or sub-species sativa, indica, or ruderalis or any hybrid derivatives of these species.

### SUMMARY

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated hardware circuits, such as an embedded processor, a computer program, and/or software. It is expected that one of ordinary skill, notwithstanding possibly significant effort and many design choices motivated by, for example, available time, current technology, and economic considerations, when guided by the concepts and principles disclosed herein will be readily capable of generating such software instructions or hardware components with minimal experimentation. Therefore, in the interest of brevity and minimization of any risk of obscuring the principles and concepts according to the present invention, further discussion of such software and hardware, if any, will be limited to the essentials with respect to the principles and concepts used by the exemplary embodiments.

The invention refers to two objects: “The Process” [100], and “The Platform” [200]. “The Process” [100] is defined as the method used to deploy, and use the Invention. “The Platform” [200] consists of the components (software, algorithm, user interfaces) that are enabling components for “The Process” [100] to be used.

### Example

In one embodiment of the present invention, an image, or multiple images of a cannabis plant is captured using a camera, and is transmitted to a computer that is running a machine learning algorithm which then returns a possible diagnostic cause(s) for the plant condition along with recommendations for remediation solutions.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram illustrating an exemplary method for diagnosing plant health in accordance with various exemplary embodiments of the present invention;

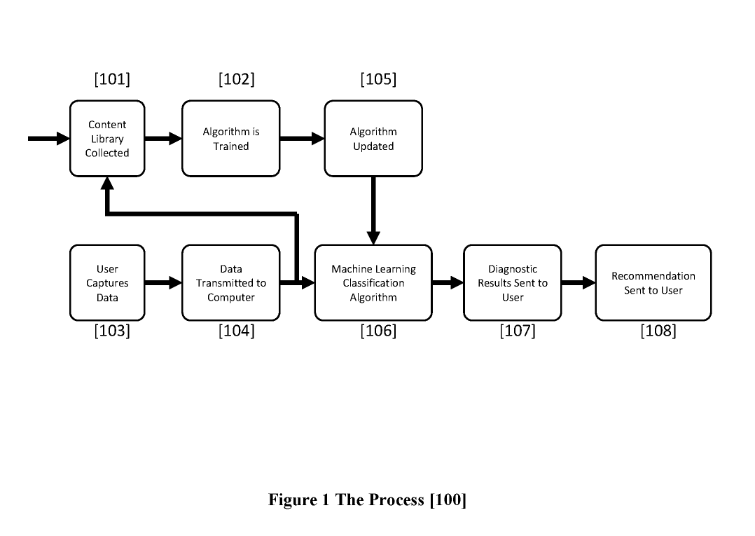

FIG. 2 is a diagram illustrating an exemplary platform for implementing the methods above in accordance with various exemplary embodiments of the present invention.

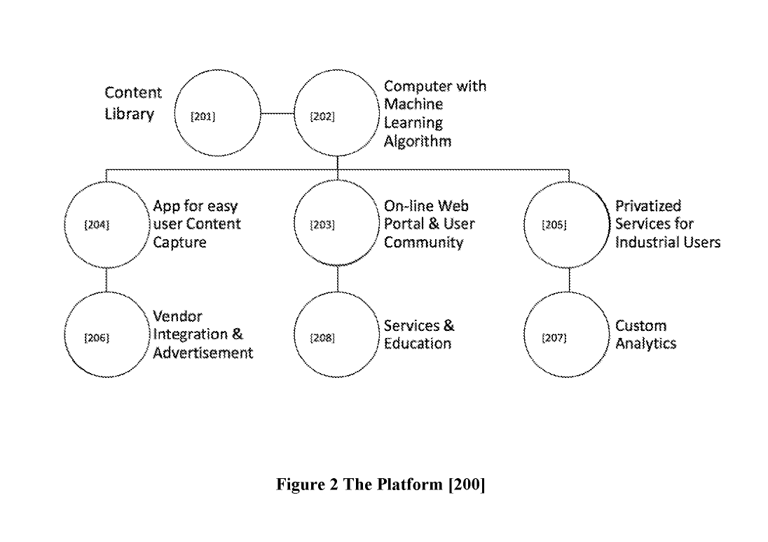

### THE PROCESS

“The Process” [100] is a method to process user data [103] that a user will upload as a query [104] to a processing algorithm [106] for 1) the purpose of generating a diagnostic response [107] that is specific to the content contained in the query, in this case for cannabis plant health and 2) for directing remediation via generic or vendor specific recommendations [108]. The process then allows 3) updating the content library [101] which is then used to re-train the algorithm [102] and then to update the machine learning algorithm [105] will in turn produce increasingly better diagnostic results for future execution of the process.

### THE PLATFORM

“The Platform” [200] are the components that enable the use of the Invention through “The Process” [100]. The primary component of “The Platform” is the machine learning algorithm running on a computer [202]. The machine learning algorithm has been trained using a set of test data included in a content library [201]. “The Platform” enables user queries through a web interface or a mobile application. The mobile application [204] allows users to submit queries and receive a diagnostic result and remediation recommendations along with relevant vendor advertisements [206]. The On-line Web Portal & User Community [203] contains a means for users to interact, and upload user content. “The Platform” may also facilitate access to this content library for private services [205]. These private services may construct a private content library that is only accessible to a specific user(s). Customized analysis [207] services may also be provided on the privatized content library.

### DETAILED DESCRIPTION OF PREFERRED EMBODIMENTS

A content library containing pairs of data comprised of (input data, and classification metadata) is collected [101]. The content library is a dataset that is used to train a machine learning algorithm [102] to learn a new task. This training dataset is what machine learning programs use to learn how to create correlation between an input query and an output classification. The training dataset contains pre-defined pairing between example input data along with their correlated output classification. The dataset may contain any such pairing of input/output data that is useful for the correlation task. One preferred embodiment is a dataset that contains pictures of unhealthy plants paired with a classification of why the plant is unhealthy, for example, low pH. Another embodiment could use a dataset that contains environment sensor data. Other dataset pairs are also possible.

The machine learning algorithm is updated [105] with new parameters learned during training. The machine learning algorithm, once trained, can generate classification for new content queries [106]. Multiple datasets and multiple machine learning algorithms may be used.

A user captures data that represents the health or state of a cannabis plant [103]. Examples of this data could include images, live or pre-recorded video, or environmental sensor data. One exemplary embodiment uses ambient sensor data such as humidity, or pH, or light spectrum, or luminance, or or lux. Other types of data inputs could also be used with this invention.

The data is submitted as a query [104] for the purpose of determining diagnostic information about the plant health.

The data is processed through a machine learning algorithm [106] which responds with a set of weighted classifications that identify probable diagnostic information on the cannabis plant. Some examples of returned diagnostic information include nutrient toxicity or deficiency, pH, poor light conditions, or over/under watering. Other classifications are possible.

The diagnostic response is returned to the user [107] along with a remediation recommendation to resolve the diagnostic condition [108]. The recommended response may optionally include a match to products or services to remediate the condition.

Any new query data is used to incrementally improve the underlying diagnostic process. The user data is verified and then added to the content library [101]. The updated content library may be used to further retrain the machine learning algorithm [102]. This retraining may be done to improve the accuracy of the classification process or to increase the types of classification results supported by updating the machine learning parameters [105]. Other adaptive improvements are also possible through the retraining process based on the type and amount of content that is collected into the dataset library.

“The Platform” [200] is a service framework that provides one or more user input methods for content capture of cannabis plant health data which is then processed and used to return a custom diagnostic response.

The preferred embodiment of this framework consists of a public web page, and/or a mobile application that collects the user contributed data; combined with an enterprise cloud based service (examples are Amazon Web Services, Microsoft Azure, or other private network or locally installed services) that processes that user submitted content queries using machine learning algorithms and responds with diagnostic classifications and remediation recommendations.

Other exemplary embodiments of “The Platform” may include a user facing advertising portal that matches vendor products and/or services based on returned diagnostic results which are funded by vendor product placement, or click-through traffic, or other contractual based contract based revenue.

Other exemplary embodiments of “The Platform” may include a premium user-subscription based service that offers private user data upload & custom site based analytics [205].

Other exemplary embodiments of “The Platform” may include an on-line user community deployed as a forum environment wherein users may submit data with or without a classification pairing. This data may be harvested for use in the content library [201].

Other exemplary embodiments of “The Platform” may include a public and/or private library of cannabis plant health diagnostic information specific to cannabis plant health conditions.

Other exemplary embodiments of “The Platform” may include education services [208] to further increase the value of the user activity. Examples of education services are on-line videos, classes, encyclopedia of plant health diagnostics. Other education services are possible. The education services increase user subscriptions, and hence user submissions and improved performance of the algorithm.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications of variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various algorithms and processes, described above can be implemented in software, hardware circuits, or combinations as desired by implementation.

What is claimed is:

1. Diagnosing cannabis plant health using a machine learning algorithm.

2. A process for providing cannabis plant health diagnostics wherein:
a. a user queries the process by submitting environmental data and
b. the data is processed with a machine learning algorithm and
c. the process returns a diagnostic response.

3. A process article of claim 2 wherein the user query data consists of a photographic image.

4. A process article of claim 2 wherein the user query data consists of motion video.

5. A process article of claim 2 wherein the user query data consists of ambient sensor data.

6. A process article of claim 2 wherein the process diagnostic response includes a remediation that contains a generic or vendor specific recommendation.

7. A process article of claim 2 wherein a content library is updated with data harvested from user submissions, and/or user discussion forums.

8. A process article of claim 2 wherein the process is performed through a privatized portal and further generates customized analytics on the generated responses.

9. A process article of claim 2 wherein user queries are generated through a mobile device application.

10. A process article of claim 2 wherein user queries are generated through an internet website application.

11. A process article of claim 2 wherein user queries are increased by offering education services.
